(19) United States
(12) Patent Application Publication
(10) Pub. No.: US 2021/0112437 A1
(43) Pub. Date: Apr. 15, 2021

(54) User Plane QOS Bearer Control Method for 5G Fixed Access

(71) Applicant: TELEFONAKTIEBOLAGET LM ERICSSON (PUBL), Stockholm (SE)

(72) Inventor: Changzheng WU, Shenzhen (CN)

(73) Assignee: TELEFONAKTIEBOLAGET LM ERICSSON (PUBL), Stockholm (SE)

(21) Appl. No.: 16/981,655

(22) PCT Filed: Mar. 13, 2019
(86) PCT No.: PCT/IB2019/052048

§ 371 Date: Sep. 16, 2020

(30) Foreign Application Priority Data
Mar. 16, 2018 (CN) PCT/CN2018/079229

(51) Int. Cl. H04W 28/02; H04W 80/02; H04W 88/16

(52) U.S. Cl. CPC H04W 28/0268; H04W 88/16; H04W 80/02; H04W 28/0263

(57) ABSTRACT

Methods relating to an access gateway AGF for managing bearer resources and traffic mapping for QoS flows between the AGF and a CPE or a UE behind a CPE when the AGF provides access to the CPE/UE to a CN (e.g., 5GC) are provided. When the AGF receives a message from 5GC comprising one or more QoS profiles with corresponding QoS flow Identifiers, QFIs, the AGF determines whether it should establish new bearers or use existing bearers for the QFIs, then creates a mapping between each of the corresponding QFIs and a bearer ID of each of the one or more bearers and may indicate the L2/L3 QOS marking to be applied at the bearer level or QoS flow level. The AGF instructs the CPE/UE to create or update the one or more bearers indicating for each bearer identifier the corresponding one or more QFIs.

### RELATED APPLICATION

This application claims the benefit of priority patent application serial number PCT/CN2018/079229, filed Mar. 16, 2018, the disclosure of which is hereby incorporated herein by reference in its entirety.

### TECHNICAL FIELD

This disclosure relates generally to User Plane QoS and 5G fixed access.

### BACKGROUND

Third Generation partnership project, 3GPP, has defined phase one for a new core network architecture for Next Generation System as described in 3GPP Technical Specification TS 23.501, 3GPP TS 23.502 and 3GPP TS 23.503. The New Core Network is also referred to as 5 Generation Core Network, 5G CN. 5GC must support:
the new 5G radio access network, New RAN (also known as G-UTRAN or NextGen RAN or NG RAN), that supports the Evolved Long-Term Evolution, eLTE eNBs and/or the new radio access network technology, NR (also known as G-UTRA) base stations, BS, also referred to as 5G NodeB, or gNB, and/or, other non-3GPP access network such as Wireless Local Area Network, WLAN.

3GPP is currently working on a study for 5G phase 2 (3GPP Release 16) which includes a study item for fixed and trusted non-3GPP access to 5GC. The study is addressed in a technical report, 3GPP TR 23.716, that describes the issues for the Wireless and Wireline Convergence for the 5G system architecture. Similarly, the Broadband Forum, BBF, is also studying fixed access in 5G context. BBF study SD-407 is a preliminary study and SD-420 contains the cleanup architecture and a description of the key issues.

An example of a High-level architecture for 5G fixed access to 5GC (or Wireline and Wireless Convergence, WWC) is illustrated in FIG. 1 (Prior art). In FIG. 1, both CPE (or 5G-Residential Gateway, RG) and device or UE connected from behind CPE are illustrated and are considered in both 3GPP and BBF.

A number of key issues related to User Plane, UP, resource management for 5G fixed access to 5GC are raised in both 3GPP TR 23.716 and BBF SD-420. The key issues from 3GPP perspective are summarized in 3GPP TR 23.716 as key issue #15, #6 and #8.

Key issue #15 is stated in clause 5.2.15 Session Management support of 3GPP TR 23.716 as studying how the Protocol Data Unit, PDU, session type is applicable to the following two scenarios
1) 5G-RG and RG connected to 5GC where 5G-RG is a RG capable of connecting to 5GC playing the role of a UE with regard to the 5G core. It supports secure element and exchanges N1 signalling with 5GC and the RG is a device capable of providing voice, data, broadcast video, video on demand, specified by BBF.
2) 3GPP UE connect to the 5GC via a 5G-RG/RG. Editor's note: The scenario of devices connected to 5G which are not 3GPP UE (e.g. laptop, PC table not supporting N1 interface) is FFS. Key issue #6 is stated in clause 5.2.6 “UP transport” of 3GPP TR 23.716 as studying how the User plane traffic can be carried between the Customer Premises and the UPF;

Following cases will be considered:
1) Traffic for a 5G-RG that supports NAS;
2) Traffic for a FN-RG that does not support NAS;
3) Traffic from UE reaching the 5GC via a 5G-RG/Fixed Network, FN-RG, where FN-RG is a RG playing a role similar of a UE with regard to the 5G core. It does not support N1 signalling to 5GC. The FN-RG is a RG specified by BBF TR124i5.

Key issue #8 is stated in clause 5.2.8 “How to support QoS in SWWC” of 3GPP TR 23.716 as studying how the 3GPP QoS model can be used in wireline access scenario. Two scenarios shall be investigated for this key issue. That is 5G-RG/ FN-RG, as UE and UE behind 5G-RG/FN-RG,
1. Study what QoS can be supported for wireline access given fixed and 3GPP QoS model differ;
2. Study how to transport the QFI and reflective QoS indication;
3. Study how to map 3GPP QoS to non-3GPP QoS.
4. Study how to interwork/prioritize between QoS policies applicable for an 5G-RG/FN-RG and a UE behind 5G-RG/FN-RG.

The key issue from BBF perspective is summarized in SD-420 as key issue #5 and described in clause 6.5 “Resource Management in the Access”. Key issue #5 states that the wireline access network has finite resources such that requests for network resource may not be able to be honored. This is exacerbated by the requirement for coexistence and the associated sharing of network resources between multiple entities. There are several aspects to this:

1. Ability to reserve resources in the access network

2. Integration of access network resource lifecycle management (reserve, release, modify) into 3GPP procedures.

3. Coordination of configuration of connectivity between the 5G-RG and the AGF.

Note: resource management includes QoS support.

In addition, 5G QoS model is defined in 3GPP TS 23.501, FIG. 2 (Prior art) shows the QoS flows to UP resource mapping for 3GPP access as specified in 3GPP TS 23.501 (phase 1).

### SUMMARY

Embodiments are provided to support PDU session management for managing UP resources for devices (UE, CPE) connected to 5GC over fixed access including a scenario of a standalone CPE or RG connected to 5GC through fixed access network and a scenario of a UE/device behind the CPE connected to 5GC. A key aspect for the UP resource management is QoS enabled bearer setup that is compatible with the end-to-end 5GC QoS model illustrated in FIG. 2 (prior art) for 3GPP access.

In one aspect, a UP QoS bearer control method to support UP resource management for PDU session of 5G fixed access is provided. More particularly, UP QoS bearer control method for CPE connected to 5GC through fixed access as well as for UE/device behind CPE connected to 5GC is provided.

In one aspect, a UP bearer for fixed access network is described and QoS mapping method to support UP setup for PDU session over fixed access network to 5GC is provided.

In another aspect, for UE/device behind CPE, two UP QoS bearer models supported in CPE are provided: bearer proxy model where the CPE or RG acts as a proxy between the UE/device and the Fixed Access Gateway Function FAGF illustrated in FIG. 1 (Prior art) (henceforth referred to as AGF) and bearer pass-through model where the CPE or RG simply relays between the UE and the AGF.

According to an aspect, a method of managing resources in a fixed access network between a device and a core network is provided. The method is executed at an Access gateway that provides access for the device to the core network, the method comprises the step of upon receiving a message from the core network that comprises a Quality of Service, QoS, request and one or more QoS profiles with corresponding QoS flow Identifiers, QFIs, determining that one or more bearers are required with the device for the one or more QFIs and creating a mapping between each of the corresponding QFIs and a bearer identifier of each of the one or more bearers and instructing the device to create or update the one or more bearers and indicating for each bearer identifier the corresponding one or more QFIs.

According to an aspect, the mapping further comprises a Layer 2 and/or Layer 3 QoS marking.

According to another aspect, the Layer 2 QoS marking corresponds to Discard Eligibility Indicator, DEI, /Priority Code Point, PCP, of a Virtual Local Area Network identity, VLAN ID and the Layer 3 QoS marking corresponds to Diffsery Code Point, DSCP.

According to another aspect, the Layer 2 and/or Layer 3 QoS marking are mapped to and applied on a per bearer or applied on a per QoS Flow.

According to another aspect, determining that one or more bearers with the device are required for the one or more QFIs further comprises determining that one or more bearers should be created for the one or more QFIs and/or determining that one or more QFIs are mapped to one or more existing bearers.

According to an aspect, a method of mapping uplink traffic at a wireless device, which may be a User Equipment, UE, accessing a core network through a fixed access network, the method executed at a wireless device and comprises the step of obtaining a mapping between one or more Quality of Service, QoS, Flow Identifiers, QFI, and one or more bearer Identifiers for bearers established between the wireless device and an access gateway over the fixed access network; and performing traffic mapping of uplink traffic based on identifying the QFI for an uplink flow and determining the corresponding bearer based on the bearer identifier mapped to the QFI.

According to another aspect the method at the device further comprises obtaining a Layer 2 and/or Layer 3 QoS marking and where the Layer 2 QoS marking may correspond to for example Discard Eligibility Indicator, DEI, /Priority Code Point, PCP, of a Virtual Local Area Network identity, VLAN ID and the Layer 3 QoS marking corresponds to Diffsery Code Point, DSCP.

In accordance with one aspect, the Layer 2 and/or Layer 3 QoS marking are mapped to and applied on a per bearer or applied on a per QoS Flow.

In accordance with another aspect, the method further comprises the step of including in the transmitted uplink traffic for each packet the QFI associated with the QoS flow of the packet, a corresponding bearer identifier of the bearer over which the packet is transmitted, a packet data session identifier associated with the bearer or a user identity identifying a user of the wireless device.

In accordance with one aspect, the wireless device is a Customer Premise Equipment which may communicate with a User equipment over a first bearer and to an access gateway over a second bearer and where the bearer established between the User equipment and the access gateway is realized by concatenating the first bearer and the second bearer.

In accordance with another aspect, the method further comprises obtaining at the Customer Premise Equipment a mapping between the first bearer and the second bearer.

In accordance with yet another aspect, the method comprises another step of applying corresponding Layer 2 and/or Layer 3 QoS marking for each packet belonging to a QoS flow and transmitted over the bearer in accordance with the received mapping.

According to one aspect, a Computer program, comprising instructions which, when executed on at least one processor, cause the at least one processor to carry out the method according to any of the embodiments herein.

According to an aspect, a carrier containing the computer program wherein the carrier is one of an electronic signal, optical signal, radio signal, or computer readable storage medium.

A network entity (102) implementing:

According to one aspect, an access gateway function is adapted to perform any of the embodiments of the network method provided herein.

According to another aspect, a network entity implementing an access gateway function comprises at least one processor; and memory comprising instructions executable by the at least one processor whereby the network entity is operable to perform any of the embodiments described herein.

In accordance with one aspect, a wireless device for mapping uplink traffic for transmission to a core network through a fixed access network is provided and which comprises a processing module to obtain via a communication module a mapping between one or more Quality of Service, QoS, Flow Identifiers, QFI, and one or more bearer Identifiers for bearers established between the wireless device and an access gateway over the fixed access network as well as to perform traffic mapping of uplink traffic based on identifying the QFI for an uplink flow and determine the corresponding bearer based on the bearer identifier mapped to the QFI and to store in a memory module the obtained mapping. The wireless device also comprises the communication module to send and receive control signaling for establishment and update of the one or more bearers and send and receive traffic over the established bearers. The wireless device also comprises the memory module to maintain the stored mapping.

In accordance with yet another aspect, the wireless device is further configured to operate according to any of the embodiments herein.

This summary is not an extensive overview of all contemplated embodiments and is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

The accompanying drawing figures incorporated in and forming a part of this specification illustrate several aspects of the disclosure, and together with the description serves to explain the principles of the disclosure.

FIG. 1 (prior art) illustrates one example of a fixed access to 5GC architecture.

FIG. 2 (prior art) illustrates 5G QoS model as described in 3GPP TS 23.501.

FIG. 3 illustrates an example of a mapping table between the QFI, bearer ID, and L2/L3 marking in accordance with an embodiment.

FIG. 4 illustrates an example packet carrying PDU payload on given UP bearer, according to an embodiment.

FIG. 5 illustrates an example embodiment of a UP bearer setup during a PDU session procedure for CPE in 5G fixed access.

FIG. 6 illustrates the Uplink traffic mapping at the CPE for transmission to the AGF in accordance to an embodiment.

FIG. 7 illustrates an example embodiment of a UP bearer setup during a PDU session procedure for CPE pass-through model in 5G fixed access.

FIG. 8 illustrates an example embodiment of a UP bearer setup during a PDU session procedure for CPE proxy model in 5G fixed access.

FIG. 9 illustrates a user plane protocol stack between the UE and the AGF for the CPE pass through model and proxy model in accordance with an embodiment.

FIGS. 10a and 10b illustrate T bearer-Uf bearer mapping in accordance with some embodiments.

FIG. 11 illustrates a method executed at an AGF in accordance with an embodiment.

FIG. 12 illustrates a method executed at a UE/CPE in accordance with some embodiments.

FIG. 13 illustrates a circuitry of a network node implementing AGF, according to an embodiment.

FIG. 14 illustrates a circuitry of a network node implementing AGF, according to another embodiment.

FIG. 15 illustrates a virtualization environment in which AGF according to some embodiment(s) may be implemented.

FIG. 16 illustrates a circuitry of a UE/CPE, according to an embodiment.

FIG. 17 illustrates a circuitry of a UE/CPE, according to another embodiment

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

As used herein, the singular forms “a”, “an” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

In the_present disclosure, a UE, which is a non-limiting term refers to any type of wireless device communicating over one or more wireless radio interfaces simultaneously with radio access nodes such as eLTE eNB, LTE eNB, 5G/NR gNB, WiFi Access point, AP or Residential Gateway, RG, over WiFi. The UE also connects with the 5GC, namely AMF/SMF over a network interface (e.g., non-access stratum, NAS, or N1). The UE may also communicate with another UE in a cellular or mobile communication system and may communicate with one or more IoT devices which use the UE as a relay or gateway to the 5GC. Examples of a UE are a Personal Digital Assistant (PDA), a tablet, mobile terminals, a smart phone, Laptop Embedded Equipment (LEE), Laptop Mounted Equipment (LME), Universal Serial Bus (USB) dongles, etc.

1. UP Bearer and QoS Mapping Method for 5G Fixed Access

In the fixed access network, this specification defines a UP bearer as a granularity of QoS enforcement which is identified by transport marking at layer 2 and/or layer 3. Transport marking can be done at layer 2, L2, of the packet such as within the Ethernet frame, in which case the marking can be DEI (Discard Eligibility Indicator)/PCP (Priority Code Point) of VID (ULAN ID). Transport marking In the layer 3, L3, packet such as Internet Protocol, IP layer, can be done via DSCP (Differentiated Services Code Point).

The AGF is responsible for managing a number of UP bearers established between the UE/device—CPE/RG and AGF which are planned/configured by the fixed access network operator. If a UE/device is not behind a CPE/RG, the UP bearer represents the bearer between the AGF and the CPE/RG. Each UP bearer is identified by a bearer Identifier, bearer ID.

QoS requirement for service traffic treatment is based on the 5G QoS model definition as specified in 3GPP TS23.501 where QoS-flow is a granularity of QoS requirement. One QoS-Flow has a unique QoS Flow Identifier, QFI to identify a QoS Flow.

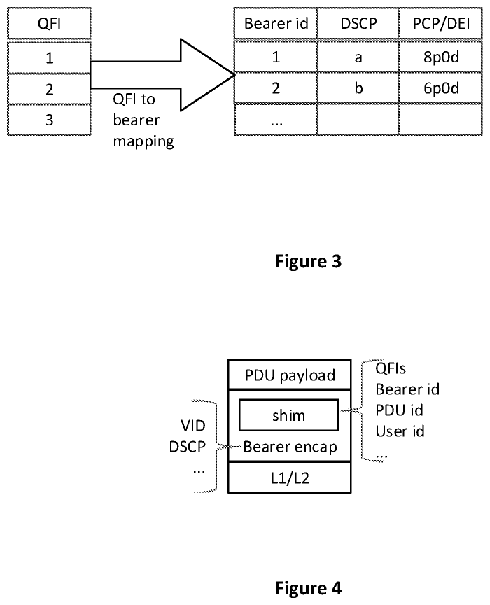

The AGF is responsible for maintaining a mapping from one or more QoS-Flows (QFIs,) to a given UP bearer (identified by the bearer ID). In M:1 mapping, group of QoS flows are mapped into same UP bearer (QoS enforcement). FIG. 3 illustrates an example of a mapping table between the QFI, bearer ID, and L2/L3 marking, where L2 marking is illustrated as PCP/DEI and L3 marking is illustrated as DSCP. Policy for AGF to perform QoS flow to UP bearer mapping can be based on operator network QoS capability.

2. Packet PDU Transport Support and Encapsulation on UP Bearer for 5G Fixed Access

FIG. 4 illustrates an example packet carrying PDU payload on given UP bearer, according to an embodiment. The packet carrying PDU payload transported on given UP bearer as proposed in this embodiment includes bearer transport level information in an encapsulation header. Example of bearer transport level information comprise VID (PCP/DEI) and/or DSCP values. The packet may also contain (in a shim header which may be part of the encapsulation) additional logical information related to the corresponding bearer, and/or PDU and/or user. Example of additional logical information comprises bearer id, PDU id and user id.

3 UP Bearer Setup Control with QoS Mapping for CPE

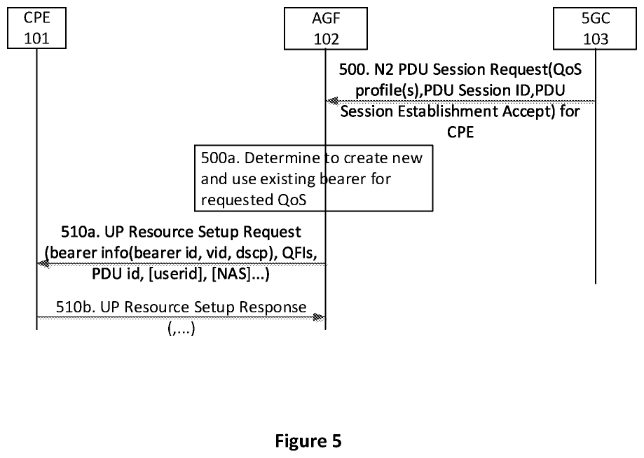

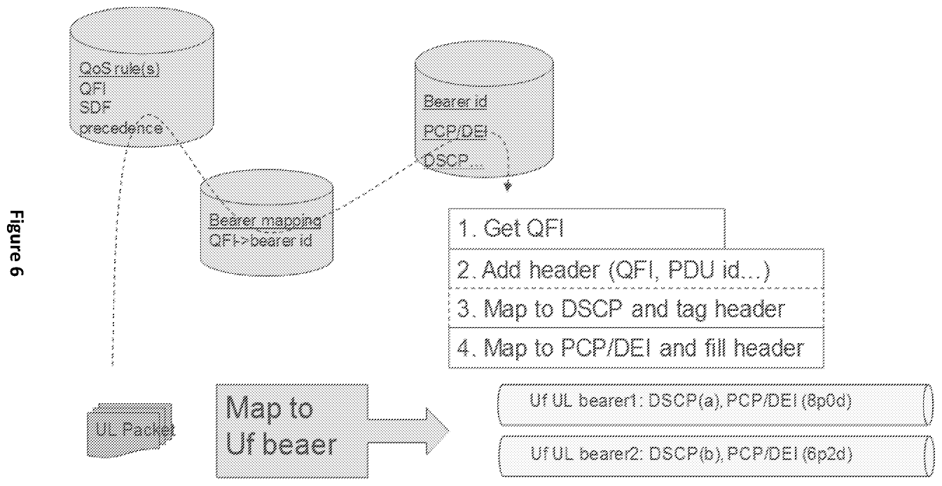

FIG. 5 illustrates an example embodiment of a UP bearer setup during a PDU session procedure for CPE in 5G fixed access.

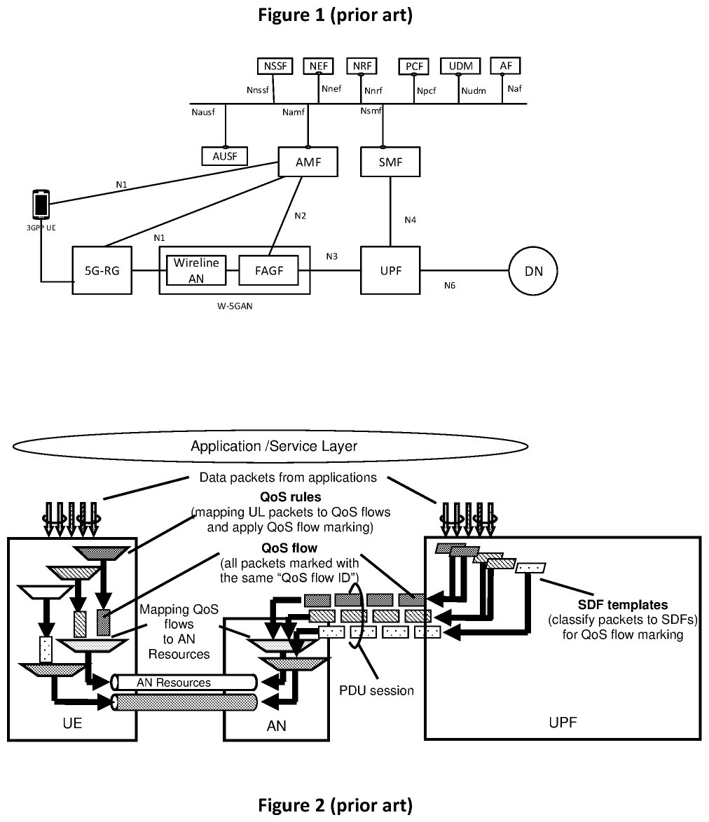

At step 500, the AGF 102 receives from 5GC 103 (e.g., AMF) an N2 PDU Session Request message (over the N2 interface as illustrated in FIG. 1) in response to a NAS PDU Session Establishment request sent from the CPE (or 5G-RG) 101 to AMF in 5GC 103 over N1 (as illustrated in FIG. 1). The PDU Session Establishment request is not shown in FIG. 5, however it is similar to step 1 of PDU session establishment via untrusted non-3GPP access specified in clause 4.12.5 of 3GPP TS 23.502. The message at step 500 instructs the AGF to establish the access resources for the PDU Session. The message at step 500 comprises one or multiple QoS profiles and the corresponding QFIs, the PDU Session ID which may be used by the fixed access network, FAN, signaling with the UE to indicate to the UE the association between FAN resources and a PDU Session for the UE. The message further comprises an N1 SM container that contains the NAS PDU Session Establishment Accept that the AMF shall provide to the UE in response to the PDU Session Establishment Request that is not shown in FIG. 5. Multiple QoS Rules and QoS Profiles may be included in the PDU Session Establishment Accept within the N1 Session Management, SM, and in the N2 SM information.

At step 500a, the AGF 102 determines whether to create a new or use an existing UP bearer for the requested QoS flows. Note that there is an N:M relationship between the QoS Flow and the UP bearer and where N=M or N #M.

At step 510a, the AGF 102 signals to the CPE 101, an UP resource message that contains UP bearer info (for a new UP bearer or an existing UP bearer) as well as QFIs to UP bearer mapping, to allow the CPE to perform uplink traffic mapping and marking when transmitting uplink traffic to the AGF 102. The UP resource message may contain the NAS PDU session Establishment Accept message received from 5GC 103 and that contains one or more QoS Rules. Each QoS Rule may include one or more uplink packet filters (and may also include one or more downlink packet filters). At step 510b, the CPE 101 installs the QoS Rules and stores the received mapping from AGF and responds to the AGF indicating that the UP bearer is established and/or the QoS mapping is accepted and successfully installed.

The CPE 101 maps uplink traffic according to uplink packet filters in QoS rules (one or more QoS Rules are received in the NAS PDU Session Establishment Accept). As indicated, the NAS message is either piggybacked in the UP resource message or received as an individual message following the UP resource message. The CPE 101 then determines the QFI for the mapped traffic. The CPE 101 then applies the QFI to bearer mapping as per FIG. 3, at which point the UP bearer to which the traffic is mapped is identified and the traffic is transmitted over that UP bearer. The CPE 101 further performs QoS enforcement, by encapsulating and marking the uplink packet according to L2/L3 marking provided in the mapping. This include marking packet with VID (DEI/PCP) and/or DSCP as well as possibly adding a shim header in the transmitted packet to contain the QFI etc. FIG. 6 illustrates the Uplink traffic mapping at the CPE 101 for transmission to the AGF 102 in accordance to an embodiment as described herein.

4. UP Bearer Setup Control with QoS Mapping for Device/UE in CPE Pass-through Mode

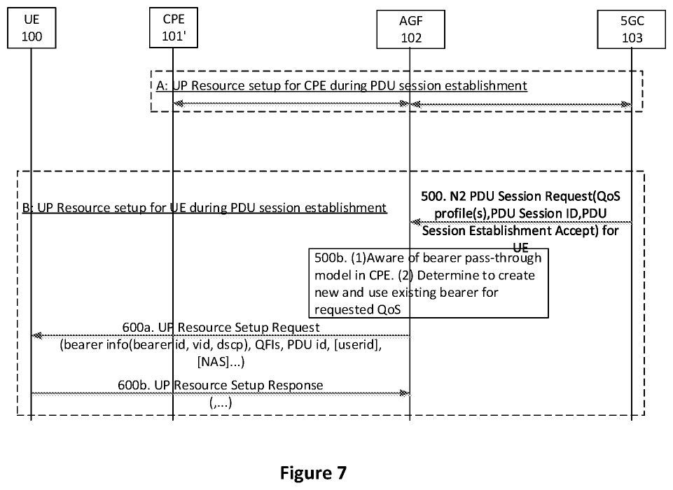

FIG. 7 illustrates an example embodiment of a UP bearer setup during a PDU session procedure for CPE pass-through model 101′ in 5G fixed access, i.e., a UE/device 100 is behind the CPE or 5G-RG 101′ but the CPE 101′ behaves as a relay or bridge (e.g., L2 bridge) and any communication between the AGF 102 and the UE 100 is relayed by the CPE 101′ and is transparent to the CPE 101′. The UP bearer is established between the UE 100 and the AGF 102 transparently (relayed) through the CPE 101′.

Step 500 is the same as step 500 of FIG. 5. Step 500b, it is assumed that the AGF 102 is aware that the CPE 101′ acts as a CPE pass-through model. The AGF 102 may know the CPE pass-through model via configuration or via signalling between the CPE 101′ and the AGF 102. For example, the CPE-AGF interaction prior to the UP bearer setup procedure could be used to indicate the CPE model to the AGF 102.

Further, at step 500b, the AGF 102 determines whether to create new or use existing UP bearer for the requested QoS with the UE/device 100. This is similar to step 500a in FIG. 5 above. Step 600a and 600b are similar to step 510a and 510b of FIG. 5 as the CPE 101′ simply relays the UP resource message. The UP bearer is established between the UE 100 and the AGF 102 through the CPE 101′. Uplink traffic mapping by the UE 100 is similar to the uplink traffic mapping described in FIG. 5.

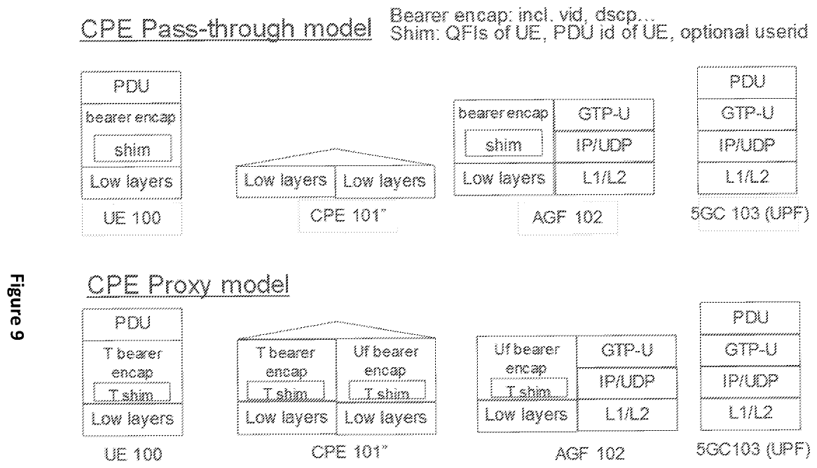

The user plane protocol stack between the UE 100 and the AGF 102 for the CPE pass through model is illustrated in FIG. 9.

5. UP Bearer Setup Control with QoS Mapping for Device/UE in CPE Proxy Model

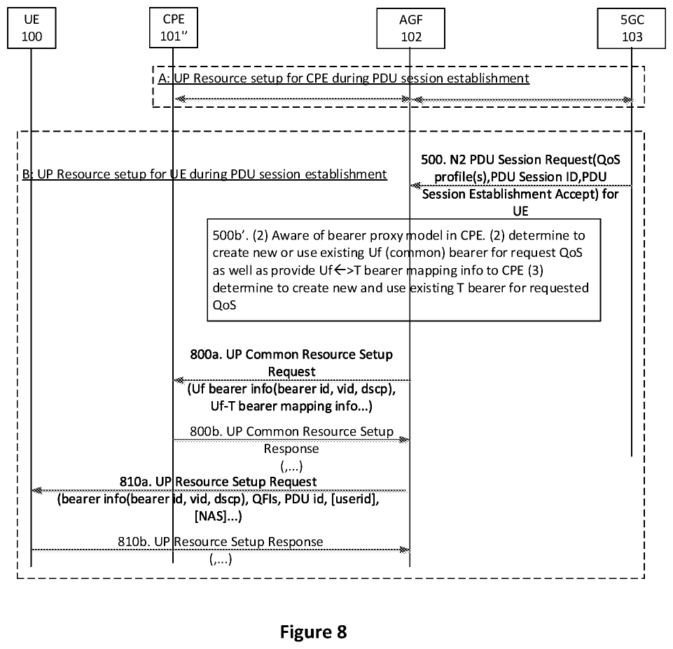

FIG. 8 illustrates an example embodiment of a UP bearer setup during a PDU session procedure for CPE proxy model 101″ in 5G fixed access, i.e., a UE/device 100 is behind the CPE or 5G-RG 101′ and the CPE 101″ behaves as a proxy for all communication between the AGF 102 and the UE 100, and where the communication is no longer transparent to the CPE 101″. The UP bearer is realized by concatenating a T-bearer established between the UE 100 and the CPE 100″ and a Uf bearer established between the CPE 101″ and the AGF 102.

Step 500 is the same as step 500 of FIG. 5. Step 500b′, it is assumed that the AGF 102 is aware that the CPE 101″ acts as a CPE proxy model. The AGF 102 may know the CPE proxy model via configuration or via signalling between the CPE 101″ and the AGF 102. For example, the CPE-AGF interaction prior to the UP bearer setup procedure could be used to indicate the CPE model to the AGF 102. Further, at step 500b′, the AGF 102 determines whether to create new or use existing Uf bearer with CPE 101″ for the requested QoS. The AGF 102 may may determine whether to create or use an existing T bearer and may provide a Uf to T bearer mapping to the CPE 101″. Just like in FIGS. 5 and 7, the GF 102 maintains the bearer to QFI, L2/L3 mapping as illustrated in FIG. 3.

At step 800a, the AGF 102 will either create or update the Uf bearer for requested QoS/mapping for the device/UE 100. The AGF sends a UP common resource setup request that comprises Uf bearer information and the mapping information (UP bearer id, VID, DSCP) and may include the Uf-T bearer mapping if AGF 102 has determined that an existing T bearer should be used for the QoS request. If the AGF 102 has determined that a T bearer should be established for the QoS flow, it may send the Uf-T bearer mapping to the CPE 101″ in a separate message after it has secured the UE 100 has established the T-bearer with the CPE 101″. Alternatively, if the CPE 101″ instead is responsible for managing the T bearers with the UE 100, it maintains its own Uf to T bearer mapping in which case the CPE 101″ would determine if it needs to create or reuse an existing T bearer. The embodiment in FIG. 8 assumes the AGF 102 manages both the Uf bearer and T bearer.

Step 810a is used to signal bearer info as well as QFIs to bearer mapping to device/UE 100 especially for uplink traffic handling. This step is similar to step 510a of FIG. 5 and Step 600a of FIG. 7.

In the proxy model, Uf bearer is common UP resource used by both the CPE 101″ and the UE/device traffic, while the T-bearer is a UP resource between device/UE 100 and CPE 101″ and is only used for device/UE traffic.

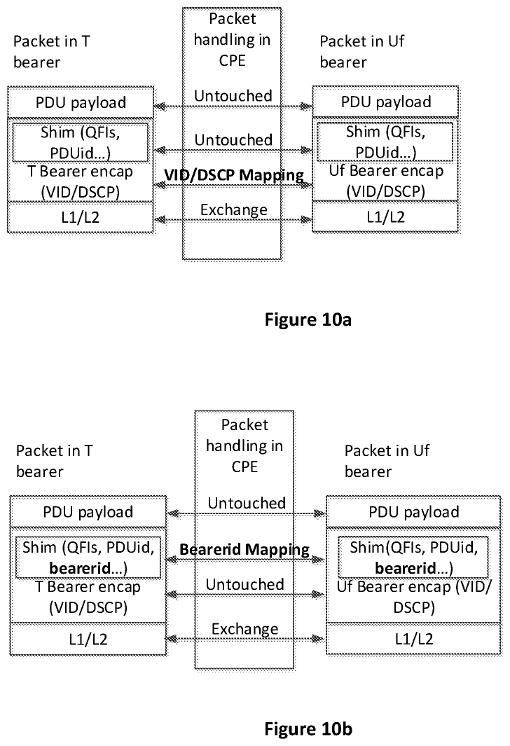

The CPE 101″ in proxy model is responsible for storing and applying Uf-T bearer mapping. T bearer (between device/UE and CPE) and Uf bearer (between CPE and AGF) mapping may be applied at L2/L3 marking level (e.g., VID/DSCP mapping) or at bearer ID level. FIG. 10a illustrates an embodiment of T bearer-Uf bearer mapping at the transport level by using VID/DSCP values that are provided by AGF 102 in the mapping information at step 800a, 810a. As shown in the FIG. 10a, VID and DSCP value in packet bearer related encapsulation is used for mapping between T bearer and Uf bearer. The upper part of the packet remains unchanged when it traverses the CPE 101″. To support this solution, the VID/DSCP values of T bearer to/from VID/DSCP values of Uf bearer mapping info should be provided to the CPE 101″ during the common UP bearer setup (in step 800a in FIG. 8).

FIG. 10b illustrates another embodiment of T bearer-Uf bearer mapping at the logical bearer ID level by using the bearer ID mapping provided by AGF 102 in the mapping information at step 800a, 810a. as shown in FIG. 10b, the bearer ID if provided within the packet header (for example within a shim header), the bearer ID is thus used for mapping between T bearer and the Uf bearer. The upper part of the packet remains unchanged when going through the CPE 101″. To support this solution, the T bearer id to/from Uf bearer id mapping info should be signaled to the CPE 101″ during the common UP bearer setup (in step 800a of FIG. 8).

The user plane protocol stack between the UE 100 and the AGF 102 for the CPE proxy through model is illustrated in FIG. 9.

Message Definition
The messages used at steps 510a/510b in FIG. 5, steps 600a/600b of FIG. 7, Steps 800a/800b and 810a/810b can be IP based protocol and may be based on WLCP specified in 3GPP TS 24.244, or the like. It could also be any suitable protocol running over layer 2.

Information Element Definition

The following table list the possible reference for the exemplary information elements used in the embodiments herein:

| Information elements | Remark |
|---|---|
| Bearer info | Including bearer id, VID, DSCP |
| QFI | As per 3GPP TS38.331 |
| PDU Id | PDU session id defined in 3GPP TS38.331 |
| [User id] | Optional, may be used as logical user id |
| | in AGF to identify different device (CPE, UE) |
| | sessions when e.g. protocol specific session |
| | id is not defined to use |
| T-Uf bearer mapping | For mapping basing on transport level info: |
| | provide transport level VID and/or DSCP |
| | of both T bearer and Uf bearer both for |
| | uplink and downlink directions |
| | For mapping basing on logical id: |
| | Provide T bearer id and corresponding |
| | Uf bearer both for uplink and downlink directions |
| VID (DEI, PCP) | |
| DSCP | |
| Bearer id | Similar to Radio Bearer, RB, identity |
| | definition of 3GPP TS38.331 |

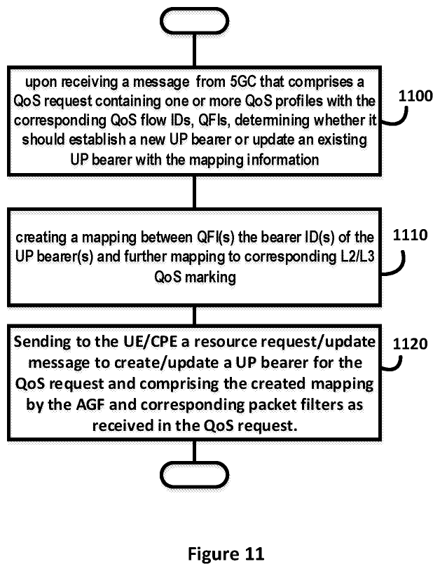

FIG. 11 illustrates a method executed at an AGF. Step 1100, the AGF executes the step of upon receiving a message over the N2 interface from 5GC that comprises a QoS request containing one or more QoS profiles with the corresponding QoS flow IDs, QFIs, determining whether it should establish a new UP bearer or update an existing UP bearer with the mapping information. One or more UP bearers may be required to support the QoS profiles. The UP bearer is a logical bearer and is identified by a bearer ID. At step 1110, the AGF proceeds with creating a mapping between QFIs and the bearer IDs and a further mapping to a L2/L3 QoS marking as shown in FIG. 3. Based on the User Id or other id included in the QoS request, the AGF would know if the QoS request is for a UE behind a CPE or for a CPE with no other device behind it. If the QoS request is for a UE behind the CPE, the AGF should determine if the CPE is or should be used as a pass-through or is or should be used as a proxy.

If the QoS request is for a CPE or for a UE behind a CPE used as a pass-through, the AGF sends at step 1120 a resource setup/update message to the CPE or the UE behind a CPE in pass through mode, where the message includes mapping information (QFI to bearer ID and may include the associated L2/L3 marking for QoS enforcement at the transport level). The message may piggyback any NAS message provided by the 5GC. The NAS message includes the one or more QoS profile with the corresponding QFIs and the QoS rule that comprise the packet filters for the flows.

If the QoS request is for a UE behind a CPE used as a proxy, if the AGF determines that an existing UP bearer should be used, it sends at step 1120 a resource setup/update message to the CPE, where the message includes mapping information (QFI to bearer ID and may include the associated L2/L3 marking for QoS enforcement at the transport level). In addition, the AGF provides the Uf bearer to T bearer mapping information. The AGF also sends a resource update message to the UE to provide it with mapping of QFI to bearer id and optionally to L2/L3 marking. If the AGF determines that a new UP bearer with a new bearer ID should be established for the QoS request, it sends at step 1120 a resource setup/update message to the CPE, where the message includes mapping information (QFI to new bearer ID and may include the associated L2/L3 marking for QoS enforcement at the transport level). The AGF also sends a resource setup message to the UE to provide it with mapping of QFI to bearer id and optionally to L2/L3 marking for establishment of the corresponding T bearer. The AGF provides the Uf bearer to T bearer mapping information to the CPE, which may be provided in a separate message after receiving an ack. That the T-bearer is established. The resource setup message sent to the UE piggyback any NAS message provided by the 5GC. The NAS message includes the one or more QoS profile with the corresponding QFIs and the QoS rule that comprise the packet filters for the flows.

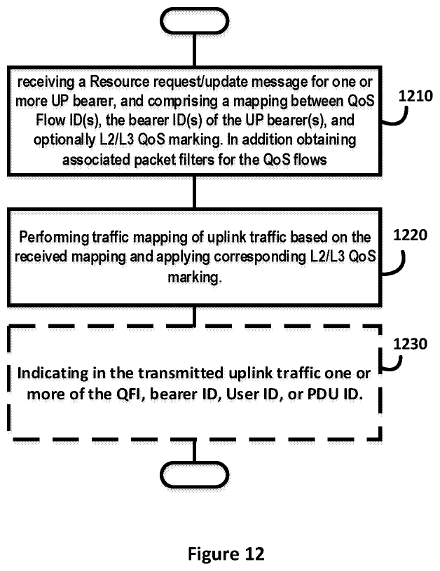

FIG. 12 illustrates a method at a UE connected directly or through a CPE to fixed access network to access the 5GC. When the UE is connected directly to fixed access network, it behaves as a CPE (e.g., CPE in FIG. 5). At step 1210, the UE obtains a resource request/update message corresponding to a QoS request for establishing or update one or more UP bearers, each identified by a bearer ID. The UP bearer is a logical UP bearer established between the UE and the AGF and is associated with a PDU session. The resource request/update comprises mapping information between a QFI and the bearer ID. The mapping may also include the L2/L3 marking (e.g., VID/DSCP) for QoS enforcement as the uplink traffic is transmitted from the UE through the fixed access network to 5GC. The UE also obtains QoS Rules and QoS profiles with corresponding QFIs and packet filters (aka Service Data Flow, SDF).

At step 1220, when the UE receives application data from an application in the UE for transmission on the uplink to the 5GC through the AGF, the UE proceeds with matching the packets against the received packet filters. Once a match is obtained, it determines the corresponding QFI. Using the stored mapping previously obtained, it determines for the QFI the corresponding bearer ID of the UP bearer over which the traffic should be transmitted. If L2 and L3 marking such as VID/DSCP is provided in the mapping, the UE applies the L2 marking and the L3 marking at the appropriate headers prior to transmitting the packet. The UE may also at step 1230 add a shim header to the packet to signal as part of the packet the QFI and/or the PDU ID of the PDU session and/or the bearer ID of the UP bearer and or the user ID associated with the PDU session.

In an alternative embodiment, if the CPE operate in a proxy mode, the CPE additionally obtains Uf bearer to T bearer mapping where the concatenation of the T bearer and Uf bearer realize the UP bearer identified by the bearer ID.

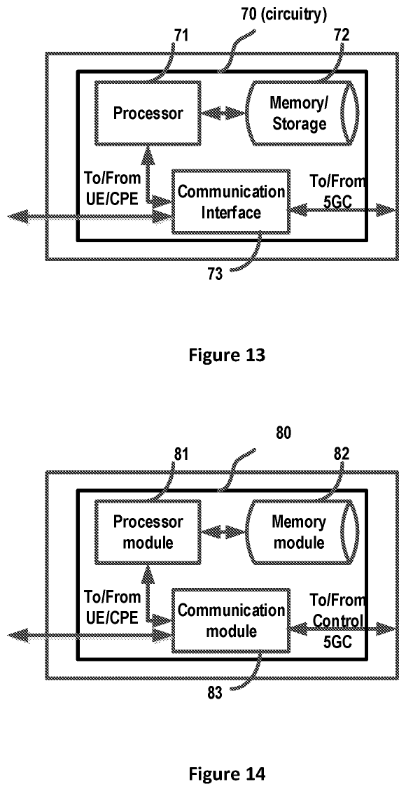

FIG. 13 illustrates an aspect of a network node implementing an AGF 102. The network node comprises a circuitry 70 which executes the method steps according to the embodiments as described in FIGS. 5, 7, 8, 9, 10a/b, 11, in addition to other embodiments described herein. The circuitry 70 may comprise one or more processors 71 and a storage 72 (also referred to as memory) containing instructions, which when executed, cause the one or more processors 71 to perform the steps according to the methods of FIGS. 5, 6, 7, 8, 9, 10a/b, 11 as described herein. The circuitry 70 may further comprise a communication interface 73 to communicate with external entities such as with UE devices/CPE and with other network nodes in 5GC over an N2 interface. The embodiments described herein can also be executed in virtualized embodiments of the AGF 102. As used herein, a “virtualized” AGF 102 is an implementation of the AGF 102 in which at least a portion of the functionality of the AGF 102 is implemented as a virtual component(s) (e.g., via a virtual machine(s) executing on a physical processing node(s) in a network(s)).

The one or more processors may include any suitable combination of hardware and software implemented in one or more modules to execute instructions and manipulate data to perform some or all of the described functions of the network node implementing the AGF 102. In some embodiments, the one or more processors may include, for example, one or more computers, one or more central processing units (CPUs), one or more processors, one or more applications, one or more application specific integrated circuits (ASICs), one or more field programmable gate arrays (FPGAs) and/or other logic. In certain embodiments, the one or more processors may comprise one or more modules implemented in software. The module(s) provide functionality of the network node implementing the AGF 102 in accordance with the embodiments described herein, and in accordance with the steps executed at the network node implementing the AGF 102 as shown in FIGS. 5, 6, 7, 8, 9, 10a/b, 11. In some embodiments, a computer program including instructions which, when executed by at least one processor, causes the at least one processor to carry out the functionality of the AGF 102 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

The memory is generally operable to store instructions, such as a computer program, software, an application including one or more of logic, rules, algorithms, code, tables, etc. and/or other instructions capable of being executed by one or more processors. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the one or more processors of the network node implementing the AGF 102.

FIG. 14 illustrates another aspect of a network node implementing a AGF 102. The network node comprises a processing module 81 which executes the method steps according to the embodiments as described in FIG. 11, in addition to other embodiments described herein. For example, the processing module 81 for the AGF 102 receives via the communication module 83 a PDU session request containing a QoS request that comprises QoS profiles with corresponding QFIs. The processing module 81 stores in the memory module 82 the received identities such as PDU ID, User ID and the QFIs and determines whether a new UP bearer should be established or an existing bearer should be used. The processing module 81 creates a mapping between QFI, bearer ID and optionally a L2/L3 marking. The processing module 81 sends via the communication module 83 a resource request message to the UE/CPE and include the creates mapping and other information received in the PDU session request such as the QoS profiles with corresponding QFIs and QoS Rules with associated packet filters. The memory module 83 maintains the received identities and the created mapping between QFI, bearer ID and optionally le L2/L3 marking.

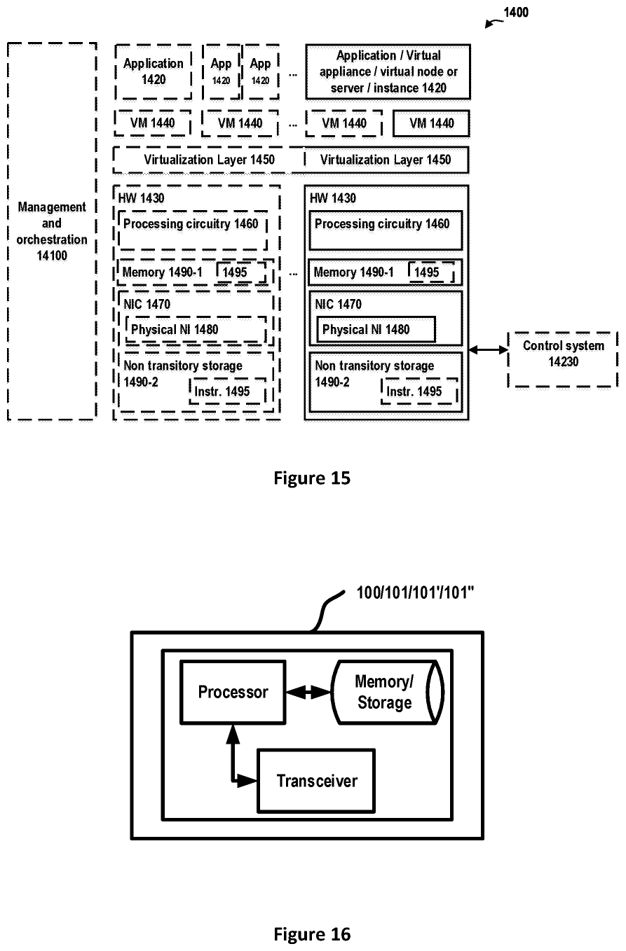

FIG. 15 is a schematic block diagram illustrating a virtualization environment 1400 in which functions such as implemented by some embodiment(s) may be virtualized. As used herein, virtualization can be applied to a network node implementing an AGF 102 as described herein and relates to an implementation in which at least a portion of the functionality is implemented as a virtual component(s) (e.g., via application(s)/component(s)/function(s) or virtual machine(s) executing on a physical processing node(s) in a network(s)).

In some embodiments, some or all of the functions described herein may be implemented as virtual components executed by one or more virtual machines implemented in a virtual environment(s) hosted by the hardware node(s) 1430. Further, in embodiments in which the virtual node is not a radio access node or does not require radio connectivity (e.g., a core network node), then the network node may be entirely virtualized.

The functions may be implemented by an application 1420 (which may alternatively be called a software instance, a virtual appliance, a network function, a virtual node, or a virtual network function) operative to implement steps of some method(s) according to some embodiment(s). The application 1420 runs in a virtualization environment 1400 which provides hardware 1430 comprising processing circuitry 1460 and memory 1490. The memory contains instructions 1495 executable by the processing circuitry 1460 whereby the application 1420 is operative to execute the method(s) or steps of the method(s) previously described in relation with some embodiment(s).

The virtualization environment 1400, comprises a general-purpose or special-purpose network hardware device(s) 1430 comprising a set of one or more processor(s) or processing circuitry 1460, which may be commercial off-the-shelf (COTS) processors, dedicated Application Specific Integrated Circuits (ASICs), or any other type of processing circuitry including digital or analog hardware components or special purpose processors. The hardware device(s) comprises a memory 1490-1 which may be a transitory memory for storing instructions 1495 or software executed by the processing circuitry 1460. The hardware device(s) comprise network interface controller(s) 1470 (NICs), also known as network interface cards, which include physical Network Interface 1480. The hardware device(s) also includes non-transitory machine-readable storage media 1490-2 having stored therein software 1495 and/or instruction executable by the processing circuitry 1460. Software 1495 may include any type of software including software for instantiating the virtualization layer or hypervisor, software to execute virtual machines 1440 as well as software allowing to execute functions described in relation with some embodiment(s) described previously.

Virtual machines 1440, implement virtual processing, virtual memory, virtual networking or interface and virtual storage, and may be run by the virtualization layer or hypervisor 1450. Different embodiments of the instance or virtual appliance 1420 may be implemented on one or more of the virtual machine(s) 1440, and the implementations may be made in different ways.

During operation, the processing circuitry 1460 executes software 1495 to instantiate the hypervisor or virtualization layer, which may sometimes be referred to as a virtual machine monitor (V120). The hypervisor 1450 may present a virtual operating platform that appears like networking hardware to virtual machine 1440. As shown in the FIG. 14, hardware 1430 may be a standalone network node, with generic or specific hardware. Hardware 1430 may be part of a larger cluster of hardware (e.g. such as in a data center or customer premise equipment (CPE)) where many hardware nodes work together and are managed via management and orchestration (MANO) 14100, which, among others, oversees lifecycle management of applications 1420.

Virtualization of the hardware is in some contexts referred to as network function virtualization (NFV). NFV may be used to consolidate many network equipment types onto industry standard high volume server hardware, physical switches, and physical storage, which can be located in Data centers, and customer premise equipment.

In the context of NFV, a virtual machine 1440 is a software implementation of a physical machine that runs programs as if they were executing on a physical, non-virtualized machine. Each of the virtual machines 1440, and that part of the hardware 1430 that executes that virtual machine, be it hardware dedicated to that virtual machine and/or time slices of hardware temporally shared by that virtual machine with others of the virtual machine(s) 1440, forms a separate virtual network element(s) (VNE).

Still in the context of NFV, Virtual Network Function (VNF) is responsible for handling specific network functions that run in one or more virtual machines on top of the hardware networking infrastructure and corresponds to application 1420 in FIG. 13.

In some embodiments, some signaling can be effected with the use of a control system 14230 which may alternatively be used for communication between the hardware node(s) 1430 and between the hardware units 1430 and external unit(s).

FIG. 16 is a block diagram of an exemplary UE 100 or CPE 101, 101′, 101″, in accordance with certain embodiments. UE or CPE includes circuitry which may comprise a transceiver, one or more processors, and memory. In some embodiments, the transceiver facilitates transmitting wireless signals to and receiving wireless signals from the Non 3GPP access (e.g., via an antenna), and transmit and receive data from the AGF 102. The one or more processors execute instructions to provide some or all of the functionalities described above as being provided by the UE 100 or CPE 101, 101′, 101″, and the memory stores the instructions for execution by the one or more processors.

The one or more processors may include any suitable combination of hardware and software implemented in one or more modules to execute instructions and manipulate data to perform some or all of the described functions of the UE/CPE as described in FIG. 5, 6. 7. 8. 9, 10a/b and 12. In some embodiments, the one or more processors may include, for example, one or more computers, one or more central processing units (CPUs), one or more processors, one or more applications, one or more application specific integrated circuits (ASICs), one or more field programmable gate arrays (FPGAs) and/or other logic. In some embodiments, a computer program including instructions which, when executed by at least one processor, causes the at least one processor to carry out the functionality of the UE 100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

The memory is generally operable to store instructions, such as a computer program, software, an application including one or more of logic, rules, algorithms, code, tables, etc. and/or other instructions capable of being executed by one or more processors. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the one or more processors of the UE 100.

Other embodiments of the UE100/CPE 101, 101′, 101″ may include additional components that may be responsible for providing certain aspects of the wireless device's, customer premise functionality, including any of the functionality described above and/or any additional functionality (including any functionality necessary to support the solution described above). As just one example, the UE 100/CPE 101, 101′, 101″ may include input devices and circuits, output devices, and one or more synchronization units or circuits, which may be part of the one or more processors. Input devices include mechanisms for entry of data into the UE/CPE. For example, input devices may include input mechanisms, such as a microphone, input elements, a display, etc. Output devices may include mechanisms for outputting data in audio, video and/or hard copy format. For example, output devices may include a speaker, a display, etc.

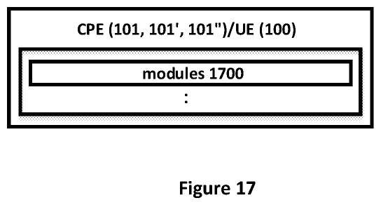

In an embodiment illustrated in FIG. 17 for the UE 100 or CPE 101, 101′, 101″ the one or more processors may comprise one or more modules 1700 implemented in software. The module(s) provide functionality of the UE/CPE in accordance with the embodiments described herein, and in accordance with the steps executed at the UE/CPE 100 in FIGS. 5, 6, 7, 8, 9, 10a/b and 12.

Acronyms and Definitions:

The following acronyms and definitions are used throughout this disclosure.

3GPP Third Generation Partnership Project

5G Fifth Generation

5GC 5G Core

AGF Access Gateway Function

AMF Access and Mobility Function

AUSF Authentication server function

BBF Broadband Forum

CN Core Network

CP Control plane

CPE Customer Premise

DEI Discard Eligibility Indicator

DSCP Differentiated Services Code Point

eNB Enhanced or Evolved Node B

FMC Fixed Mobile Convergence

FPGA Field Programmable Gate Array

gNB next generation NodeB

LTE Long Term Evolution

NAS Non-Access Stratum

NG Next Generation

NR New Radio

PCP Priority Code Point

PDU Protocol Data Unit

QDI QoS Flow Identifier

RAN Radio Access Network

RG Residential Gateway

UE User Equipment

UP User Plane

UPF User Plane Function

USB Universal Serial Bus

WiFi Wireless Fidelity

WWC Wireline Wireless Convergence

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A method of managing resources in a fixed access network between a device and a core network, the method executed at an Access gateway that provides access for the device to the core network, the method comprising:
upon receiving a message from the core network that comprises a Quality of Service, QoS, request and one or more QoS profiles with corresponding QoS flow Identifiers, QFIs, determining that one or more bearers are required with the device for the one or more QFIs;
creating a mapping between each of the corresponding QFIs and a bearer identifier of each of the one or more bearers; and
instructing the device to create or update the one or more bearers and indicating for each bearer identifier the corresponding one or more QFIs.

2. The method of claim 1, wherein the mapping further comprises a Layer 2 and/or Layer 3 QoS marking.

3. The method of claim 2, wherein the Layer 2 QoS marking corresponds to Discard Eligibility Indicator, DEI, /Priority Code Point, PCP, of a Virtual Local Area Network identity, VLAN ID and the Layer 3 QoS marking corresponds to Diffsery Code Point, DSCP.

4. The method of claim 2, wherein the Layer 2 and/or Layer 3 QoS marking are mapped to and applied on a per bearer.

5. The method of claim 2, wherein the Layer 2 and/or Layer 3 QoS marking are mapped to and applied on a per QoS Flow.

6. The method of claim 1 wherein determining that one or more bearers with the device are required for the one or more QFIs further comprises determining that one or more bearers should be created for the one or more QFIs and/or determining that one or more QFIs are mapped to one or more existing bearers.

7. A method of mapping uplink traffic at a wireless device accessing a core network through a fixed access network, the method executed at a wireless device, the method comprising:
obtaining a mapping between one or more Quality of Service, QoS, Flow Identifiers, QFI, and one or more bearer Identifiers for bearers established between the wireless device and an access gateway over the fixed access network; and
performing traffic mapping of uplink traffic based on identifying the QFI for an uplink flow and determining the corresponding bearer based on the bearer identifier mapped to the QFI.

8. The method of claim 7, wherein the method further comprises obtaining a Layer 2 and/or Layer 3 QoS marking.

9. method of claim 8, wherein the Layer 2 QoS marking corresponds to Discard Eligibility Indicator, DEI, /Priority Code Point, PCP, of a Virtual Local Area Network identity, VLAN ID and the Layer 3 QoS marking corresponds to Diffsery Code Point, DSCP.

10. The method of claim 7, wherein the Layer 2 and/or Layer 3 QoS marking are mapped to and applied on a per bearer.

11. The method of claim 7, wherein the Layer 2 and/or Layer 3 QoS marking are mapped to and applied on a per QoS Flow.

12. The method of claim 7, wherein the method further comprises including in the transmitted uplink traffic for each packet the QFI associated with the QoS flow of the packet, a corresponding bearer identifier of the bearer over which the packet is transmitted, a packet data session identifier associated with the bearer or a user identity identifying a user of the wireless device.

13. The method of claim 7, wherein the wireless device is a User Equipment.

14. The method of claim 7, wherein the wireless device is a Customer Premise Equipment.

15. The method of claim 14, where in the Customer Premise Equipment communicates with a User equipment over a first bearer and to an access gateway over a second bearer and where the bearer established between the User equipment and the access gateway is realized by concatenating the first bearer and the second bearer.

16. The method of claim 15 wherein the method further comprises obtaining at the Customer Premise Equipment a mapping between the first bearer and the second bearer.

17. The method of claim 8 further comprising applying corresponding Layer 2 and/or Layer 3 QoS marking for each packet belonging to a QoS flow and transmitted over the bearer in accordance with the received mapping.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. A wireless device for mapping uplink traffic for transmission to a core network through a fixed access network, the wireless device comprising:
at least one processor; and
memory comprising instructions executable by the at least one processor whereby the network entity is operable to:
obtain a mapping between one or more Quality of Service, QoS, Flow Identifiers, QFI, and one or more bearer Identifiers for bearers established between the wireless device and an access gateway over the fixed access network; and
perform traffic mapping of uplink traffic based on identifying the QFI for an uplink flow and determine the corresponding bearer based on the bearer identifier mapped to the QFI.

30. (canceled)

31. (canceled)
